(19) United States
(12) Patent Application Publication
(10) Pub. No.: US 2017/0303597 A1
(43) Pub. Date: Oct. 26, 2017

(54) Electronic Smoking Apparatus and Circuitry

(71) Applicant: XMART CHIP MICROELECTRONIC CO. LIMITED, Foshan (CN)

(72) Inventor: Honming Tsui, Hong Kong (HK)

(21) Appl. No.: 15/529,995

(22) PCT Filed: Jan. 21, 2016
(86) PCT No.: PCT/CN2016/071567

§ 371 Date: May 26, 2017

(30) Foreign Application Priority Data
Jan. 26, 2015 (HK) 15100851.1

(51) Int. Cl. A24F 47/00; H05B 3/06; H05B 1/02

(52) U.S. Cl. CPC A24F 47/008; H05B 1/0297; H05B 3/06

(57) ABSTRACT

An electronic smoking apparatus (100) comprising control circuitry (126), driving circuitry (122), charging circuitry (124), excitation element (128), a flavoured source (112) and a battery (114), the electronic smoking apparatus (100) being operable in a smoking mode or a charging mode; wherein excitation signals are to flow from the battery (114) to the excitation element (128) through a first switchable conductive path and in a first conduction direction when the electronic smoking apparatus (100) operates in the smoking mode, and charging current is to flow from an external charging power source to the battery (114) through a second switchable conductive path and in a second conduction direction when the electronic smoking apparatus (100) operates in the charging mode, the second conduction direction being opposite to the first conduction direction; and wherein the second switchable conductive path forms a portion of the first switchable conductive path.

### FIELD

The present disclosure relates to electronic smoking apparatus and device for operation of electronic smoking apparatus.

### BACKGROUND

Electronic smoking apparatus are an electronic substitute of their conventional tobacco burning counterparts and are gaining wide acceptance. To facilitate repeated use, electronic smoking apparatus are frequently powered by rechargeable batteries and equipped with refillable or detachable flavoured sources which are adapted to generate smoke resembling fume, vapour or aerosol to simulate smoking.

With the increasing popularity of electronic smoking apparatus, it is desirable to provide enhanced operational circuitry for their operation.

### DISCLOSURE

There is disclosed an electronic smoking apparatus comprising control circuitry, driving circuitry, charging circuitry, excitation element, a flavoured source and a battery, the electronic smoking apparatus being operable in a smoking mode or a charging mode; wherein excitation signals are to flow from the battery to the excitation element through a first switchable conductive path and in a first conduction direction when the electronic smoking apparatus operates in the smoking mode, and charging current is to flow from an external charging power source to the battery through a second switchable conductive path and in a second conduction direction when the electronic smoking apparatus operates in the charging mode, the second conduction direction being opposite to the first conduction direction; and wherein the second switchable conductive path forms a portion of the first switchable conductive path.

### FIGURES

The disclosure will be described by way of example with reference to the accompanying Figures, in which:

FIG. 1 is a schematic diagram of an example electronic smoke apparatus according to the present disclosure,

FIG. 1A is a schematic diagram depicting an example modular option of the electronic smoke apparatus of FIG. 1,

FIG. 1B is a schematic diagram depicting an example module of the electronic smoke apparatus of FIG. 1A and a compatible charging power source,

FIGS. 2A, 2B, 2C and 3 are schematic diagrams of example electronic smoke apparatus according to the present disclosure,

FIG. 4 is a schematic diagram depicting functional blocks of example operational circuitry of the example electronic smoke apparatus according to the disclosure,

FIG. 4A is a block diagram depicting functional blocks of an example control circuitry of FIG. 4,

FIG. 5 is a flow diagram depicting an example operation flow of the an electronic smoke apparatus having the arrangement of FIG. 4,

FIG. 6 is a schematic hybrid circuit and block diagram depicting example operational circuitry of an example electronic smoke apparatus,

FIGS. 6A and 6B are schematic diagrams depicting power flow paths and flow directions during example operations of FIG. 6,

FIG. 6C is a time diagram depicting variation of signals at various nodes of an electronic smoke apparatus incorporating the operation circuitry of FIG. 6 at different times of operation,

FIG. 6D is a schematic diagram of FIG. 6 with the gate select device depict in a block diagram,

FIG. 6E is schematic diagram depicting the gate select device of FIG. 6D,

FIG. 7 is a schematic hybrid circuit and block diagram depicting example operational circuitry of an example electronic smoke apparatus,

FIG. 7A is a time diagram depicting variation of signals at various nodes of an electronic smoke apparatus incorporating the operation circuitry of FIG. 6 at different times of operation,

FIG. 8 is a diagram depicting an example schematic layout of an example operation circuitry according to the disclosure, and

FIG. 8A is a schematic view depicting layout of PFET1 and/or PFET2 on a semiconductor substrate.

### DESCRIPTION

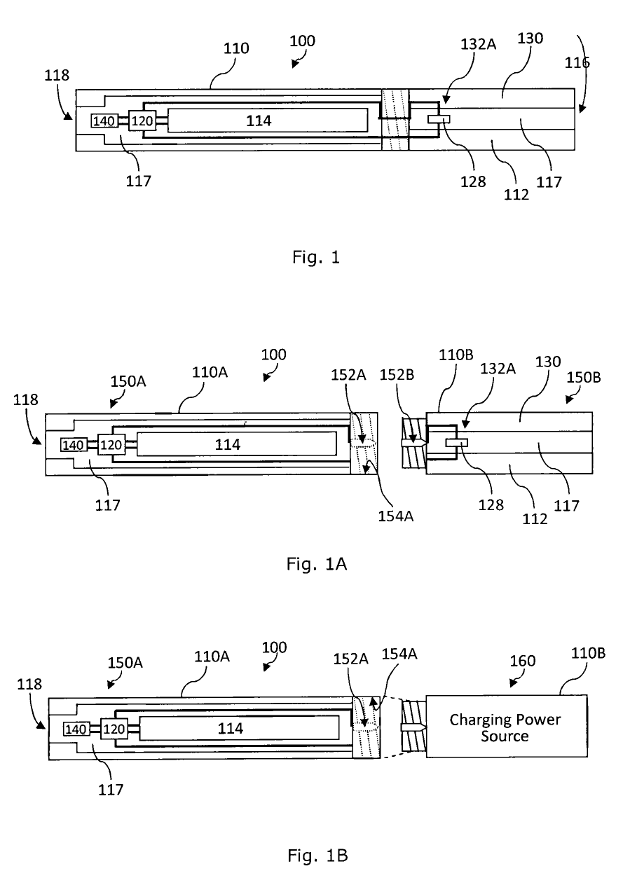

An example electronic smoke apparatus 100 depicted in FIG. 1 comprises a main housing 110 inside which a flavoured source 112, a battery 114, operation circuitry 120, excitation element 128 and puffing detector 140 are housed. The main housing 110 is elongate, hollow and defines a tubular portion which joins an inhaling aperture 116 and an air inlet aperture 118. The inhaling aperture 116 is defined at one free axial end (or the suction end) of the tubular portion, the air inlet aperture 118 is defined at another axial end which is opposite to the suction end, and a channel 117 is defined by a portion of the tubular portion interconnecting the inhaling aperture 116 and the air inlet aperture 118. The flavoured source 112 is contained inside a reservoir 130 near the suction end of the main housing 110. The reservoir has an internal wall which defines the outer boundary of the portion of the tubular portion near the suction end. A flavoured substance outlet 132 is formed on the internal wall so that flavoured substances contained in the flavoured source 112 can be released through the flavoured substance outlet 132 into the channel 117 to facilitate fume generation. The main housing 110 has a substantially circular outline to resemble the appearance of a cigarette or cigar and the suction end would serve as a mouth piece to be in contact with the lips of a user during simulated smoking operation.

In operation, air flows into the main housing 110 through the air inlet aperture 118 in response to suction of a user at the suction end. The incoming air flows along an air passageway defined by the channel 117 and exits through the inhaling aperture 116 after traversing a portion of the channel 117 which is surrounded by the reservoir 130 and picking up a flavoured fume during the passage.

The example electronic smoke apparatus 100 of FIG. 1 is detachable into a first module 150A and a second module 150B as depicted in FIG. 1A. The first module 150A comprises a first housing portion 110A and the second module 150B comprises a second housing portion 110B. The first and second housing portions 110A, 110B are axially aligned and include counterpart attachment parts to facilitate releasable attachment between the first 150A and the second 150B modules to form a single elongate and continuous piece of smoking apparatus with electrical communication between the first 150A and the second 150A modules. The counterpart attachment parts include complementary fastening counterparts to facilitate releasable fastening engagement between the first 150A and second 150B modules when axially aligned, coupled and engaged.

The puffing detector 140, the operation circuitry 120, and the battery 114 are housed inside a hollow chamber defined inside the first housing portion 110A. The first housing portion 110A is rigid and elongate and the air inlet aperture 118 is formed on or near one axial end of the first housing portion 110A to define the air inlet end of the electronic smoke apparatus 100. The hollow chamber extends from the air inlet aperture 118 to a distal axial end or coupling end of the first housing portion 110A and forms part of the channel 117. The hollow chamber has an open end at the distal axial end of the first housing portion 110A. This open end is to couple with a corresponding open end of a corresponding hollow chamber on the second module 150B. When the corresponding open ends are so coupled and connected, the complete channel 117 is formed.

An attachment part for making detachable engagement with a counterpart attachment part on the second module 150B is formed on the distal axial end of the first housing portion 110A. The attachment part comprises contact terminals for making electrical contact with counterpart terminals on the counterpart attachment part of the second module 150B. An LED (light emitting diode) such as a red LED or one with red filter may be provided as an optional feature at the inlet end of the first housing portion 110A to provide simulated smoking effect if preferred. In this example, the contact terminals include or incorporate mode sensing terminals.

The second housing portion 110B comprises an elongate rigid body having a first axial end which is the suction end and a second axial end or coupling end which is to enter into coupled mechanical engagement with the distal end of the first housing portion 110A. The rigid body includes a first hollow portion which defines another part of the channel 117. Contact terminals complementary to the contact terminals on the distal end of the first housing portion 110A are formed at the second axial end for making electrical contacts with the counterpart contact terminals on the first module 150A.The first hollow portion extends axially or longitudinally towards the inhaling aperture 116 and includes an elongate portion that is surrounded by the reservoir 130. A puffing sensor is disposed along the channel 117 to operate as the puffing detector 140 for detection of air movements representative of simulated smoking.

The second housing portion 110B includes an axially extending internal wall which surrounds the portion of the channel 117 inside the second module 150B and defines that portion of the channel 117. The internal wall cooperates with the external wall of the second housing portion 110B to define the reservoir 130. The flavoured source 112 may be in the form of a flavoured liquid such as e-juice or e-liquid. The reservoir outlet 132 is formed on the internal wall so that the reservoir 130 is in liquid communication with the channel 117 via the reservoir outlet 132. The excitation element 128 projects into the channel 117 so that a flavoured fume generated by the excitation element during operation will be picked up by a stream of air moving through the channel 117. A lead wire to provide excitation energy to the excitation element 128 extends from the contact terminals to enter the reservoir 130 and then projects into the channel 117 through the reservoir outlet 132 after traversing an axial length inside the reservoir 130 and connects to the excitation element 128. The lead wire serves as a liquid guide or liquid bridge to deliver flavoured liquid from the reservoir 130 to the excitation element 128. The lead wire also serves as a signal guide to deliver excitation signals to the excitation element 128.

An attachment part for making detachable engagement with a counterpart attachment part on the first module 150A is formed on the coupling end of the second housing portion 110B. The attachment part comprises contact terminals for making electrical contact with the counterpart terminals on the counterpart attachment part of the first module 150A. One of the contact terminals is optionally screw threaded to ensure good secure and reliable electrical contact between the first 150A and second 150B modules so that excitation power can flow reliably to the excitation element 128 from the operation circuitry 120 during operations. In this example, the excitation element 128 comprises a resistive heating element.

When the second module 150B is detached from the first module 150A, the contact terminals on the coupling end of the first module 150A are exposed. A charging power source such as a modular charging power source 160 having complementary electrical and mechanical contact terminals as depicted in FIG. 1B can be electrically coupled to the first module 150A to charge the battery 114 inside the first module 150A. Lithium ion rechargeable batteries having the identification number 68430 (6.8 mm in diameter and 43 mm in length) are widely used in electronic cigarettes. Other staple batteries that are commonly used in electronic cigarettes include lithium ion rechargeable batteries having identification numbers 18350, 18490, 18500 or 18650. The identification numbers of the latter batteries represent the dimensions in which the first two digits stand for diameter in mm and the last three digits stand for length in 0.1 mm units. Lithium ion batteries have a typical nominal voltage of about 3.6V or 3.7V and a usual power rating of several hundred mAh to several thousand mAh. Of course, rechargeable batteries of other sizes, dimensions, and materials can be used for smaller electronic apparatus of different sizes and different applications without loss of generality.

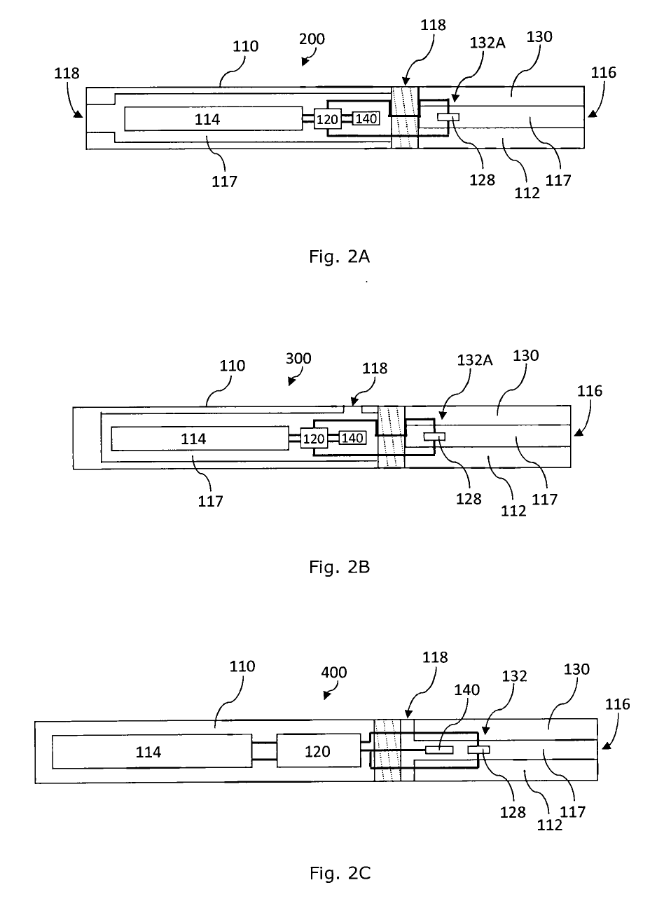

The example electronic smoke apparatus 200 depicted in FIG. 2A is substantially identical to that of FIG. 1, except that the puffing detector 140 is proximal the coupling end and between the battery 114 and the contact terminals. The operation circuitry 120 is disposed intermediate the battery 114 and the puffing detector 140 in this example.

The example electronic smoke apparatus 300 depicted in FIG. 2B is substantially identical to that of FIG. 2A, except that the air inlet aperture 118 is formed on a side of the main housing 110 and proximal the coupling end to provide an inlet path into the channel 117. In this example, the channel 117 is closed at the free axial end of the main housing which is distal from the suction end.

The example electronic smoke apparatus 400 depicted in FIG. 2C is substantially identical to that of FIG. 2B, except that the air inlet aperture 118 and the puffing detector 140 is in the portion of the main housing corresponding to the second module 150B and proximal the coupling end.

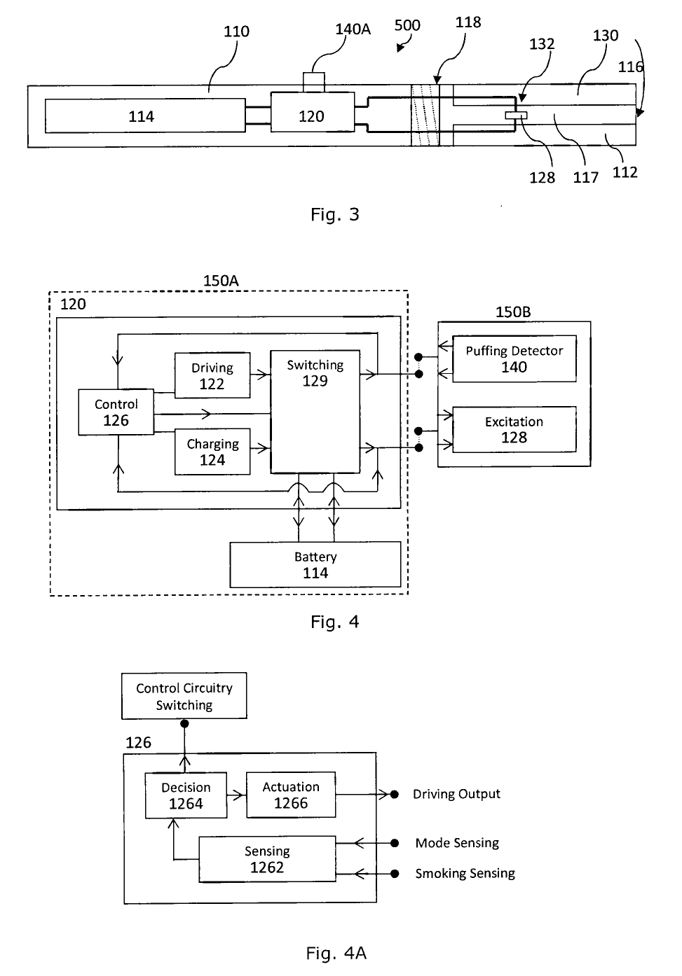

The example electronic smoke apparatus 500 depicted in FIG. 3 is substantially identical to that of FIG. 2C, except that activation is by means of a switch 140A instead of the puffing detector 140.

While various configurations have been described herein, it should be appreciated that the configurations are non-limiting examples. For example, the air inlet aperture may be on an axial free end or on a side wall of the main housing, the puff detector may be proximal the air inlet aperture or further in the channel, and the operation circuitry 120 may be inside or outside of the channel without loss of generality.

In the various example electronic smoke apparatus herein, parts and/or components having the same or equivalent functional properties or characteristics have the same reference numerals unless otherwise stated.

The puffing detector 140 comprises a frontend puffing sensor which is disposed inside the channel 117 to detect occurrence of a simulated smoking event or a simulated smoking act at the electronic smoke apparatus 100. An example frontend puffing sensor comprises an airflow sensor which is to generate signals representing conditions of air movement inside the channel 117. The air movement conditions may include airflow rate and airflow direction. The puffing detector 140 is connected to the operation circuit 120 and air movement signals generated by the airflow sensor are delivered to the operation circuit 120 for processing during operations.

A baffle type airflow sensor which is to output signals that vary according to the instantaneous strength and direction of airflow would be an example of airflow sensors suitable for use as a frontend puffing sensor. An example baffle type airflow sensor that would output signals having signal properties that are dependent on the instantaneous characteristics of airflow such as air flow strength and direction would provide useful information to facilitate operation of the operation circuit 120 for determination of whether a simulated smoking event or a simulated smoking act has occurred at the electronic smoke apparatus 100.

An example baffle type airflow sensor that is suitable for detection of smoking inhalation comprises a resilient metallic baffle plate which is mounted at a separation distance away from a reference electrode plate to form a dielectric type capacitive airflow sensor. The resilient metallic baffle plate is configured to be deformable in accordance with the direction of airflow and the extent of deformation is dependent on the strength of airflow in that direction so that the output capacitance value or other signal properties of the airflow sensor will be indicative of both the direction and strength of airflow. By disposing the airflow sensor such that the resilient metallic baffle plate or portion thereof will deform towards or away from the reference electrode plate depending on whether the direction of airflow is towards or away from the reference electrode plate, the capacitance or other signal properties output of the airflow sensor would provide the required information. The operation circuit 120 will process the output signals of the airflow sensor to determine whether an actuation condition corresponding to a simulated smoking event or a simulated smoking act has been detected.

In this example, the operation circuit 120 is configured to determine whether an inhaling event corresponding to simulated smoking has occurred at the mouth piece, or more specifically at the inhaling aperture 116, of the electronic smoke apparatus 100 according to signals output from the frontend puffing sensor during smoking mode operations.

The operation circuitry 120 comprises driving circuitry 122, charging circuitry 124, control circuitry 126 and switching circuitry 129 to facilitate operation of the electronic smoke apparatus 100, as depicted in FIG. 4. The control circuitry 126 comprises sensing circuitry 1262, decision circuitry 1264 and actuation circuitry 1266, as depicted in FIG. 4A.

The sensing circuitry 1262 comprises mode sensing circuitry and smoking event sensing circuitry. The mode sensing circuitry is for connection to a mode sensor and to process mode signals coming from the mode sensor for feeding to the decision circuitry. The smoking event sensing circuitry is for connection to a smoking event sensor and to process signals coming from the smoking event sensor for feeding to the decision circuitry. The puffing sensor 140 of FIG. 4 is an example smoking event sensor.

The decision circuitry 1264 is connected to the sensing circuitry 1262, the actuation circuitry 1266 and the switching circuitry 129.

The decision circuitry is connected to the output of the sensing circuitry 1262 and to determine whether to set in the charging mode or the smoking mode. The determination may be made by comparison of a received mode signal or an internally generated mode signal, or by comparison of the charging mode signal and the smoking mode signal. The decision circuitry comprises mode decision circuitry to facilitate comparison between a received mode signal and a reference mode signal, or to facilitate comparison between the received mode signals directly. The decision circuitry 1264 is to give a charging mode output or a smoking mode output on the outcome of the mode decision circuitry. The decision circuitry 1264 is connected to the switching circuitry 129 and to set the switching circuitry 129 into a first conduction mode or a second conduction mode. When in the smoking mode, the decision circuitry 1264 is to set the switching circuitry 129 into a first conduction mode to provide a first conduction path to allow flow of excitation power in a first direction from the battery 114 via the switching circuitry 129 to the excitation element 128. When in the charging mode, the decision circuitry 1264 is to set the switching circuitry 129 into a second conduction mode to provide a second conduction path to allow flow of charging power from an external power source in a second direction to the battery 114 and via the switching circuitry 129. The second direction is a current charging direction and the first direction is a current discharging direction opposite to the current charging direction.

In an example, the reference mode signal may be set as the battery voltage and the decision circuitry 1264 is to give a charging mode output when the received mode signal has a voltage higher than that of the battery voltage.

The decision circuitry 1264 is to determine whether to set in a fuming state and to give a fuming state output or to set in a non-fuming state and to give a non-fuming state output with reference to received air movement signals while in the smoking mode. To facilitate determination, the decision circuitry comprises smoking state decision circuitry to compare received air movement signals with a reference threshold. When in the smoking mode, the decision circuitry 1264 of the control circuitry 126 will give a fuming state output upon air receipt of air movement signals corresponding to an actuation condition. The decision circuitry will set the apparatus in the fuming state or a non-fuming state depending on the outcome of the smoking state decision circuitry. Upon initialization, the decision circuitry 1264 is to set in the non-fuming state to mitigate inadvertent or false actuation.

The actuation circuitry 1266 is connected to the output of the decision circuitry 1264 and control terminals of the charging circuitry 124 and the driving circuitry 122. When the decision circuitry gives a smoking mode output, the actuation circuitry 1266 is set into the smoking mode, with the driving circuitry enabled and the charging circuitry disabled. When the decision circuitry gives a charging mode output, the actuation circuitry 1266 is set in the charging mode, the charging circuitry is enabled and the driving circuitry is disabled.

When the decision circuitry 1264 gives a fuming state output while in the smoking mode, the actuation circuitry 1266 will operate the driving circuitry 122 to generate excitation signals using power of the battery and to deliver the excitation signals via the switching circuitry 129 to drive the excitation element 128. If no actuation condition to trigger a fuming state is detected while in the smoking mode, the decision circuitry 1264 will continue to output a non-fuming state output.

The actuation circuitry 1266 is configured to provide the driving circuitry with driving instructions such as amplitude of discharging current, duty ratio, modulation frequency, and/or other operational parameters. The driving instructions may be of a single pre-set driving pattern, a plurality of driving patterns to be selectable by the control circuitry, or may be adaptive with driving parameters set according to detected smoking characteristics.

The driving circuitry 122 is to utilize the puffing detector 140 as a frontend airflow sensor and to generate driving or excitation signals to drive the excitation element 128 when an actuation condition is detected by the control circuitry 126 when in a fuming mode. The control circuitry 126 is connected to the output of the puffing detector 140 for receipt of output signals or output data originating from the puffing detector 140 when in the fuming mode. The control circuitry will analyse the received signals or data upon receipt and determine whether the signals or data correspond to an event of smoking inhaling. When the outcome of determination indicates that the received signals or data correspond to that of an event of smoking inhaling, the received signals or data will be classified as actuation signals and the control circuitry will set the driving circuitry 122 into an actuation mode. When in the actuation mode, the driving circuitry 122 will send excitation signals to drive the excitation element 128. When driving or excitation signals are received by the excitation element 128, driving of the excitation element 128 by the driving or excitation signals will convert the flavour liquid or flavoured substances on the excitation element 128 into flavoured fume, vapour and/or aerosol. The flavoured fume, vapour and/or aerosol thus generated will flow from the flavour source 112 along the channel to the inhaling aperture 116 and then to the inhaling user.

The driving or excitation signals may be pulsed or continuous. In some embodiments, the excitation signals may be a current flowing from the battery to a heating element of the excitation element 128. The current may be constant or variable by using pulse-width-modulation (PWM). PWM modulated excitation signals would allow the control circuitry to vary or adjust the excitation power. The excitation signals may be a high frequency nebulizing vibration generated by the driving circuitry in addition to or as an alternative to heating current.

The driving or excitation signals may be adaptive or non-adaptive. Adaptive driving or excitation signals are those that change according to detected smoking characteristics of a user. Non-adaptive excitation signals are those that do not change according to detected smoking characteristics of a user. Non-adaptive excitation signals may have a pre-set variable operation pattern or of a pre-set operation amplitude. The driving circuitry may be set to generate excitation power adaptively according to suction characteristics such as suction strength or suction duration and/or according to personal preference or requirements, whether pre-set or retro-set. Typical smoking characteristics include suction or puffing power, suction or puffing frequency, suction or puffing duration, and/or the rate of change of suction or puffing power, and/or rate of change of suction or puffing frequency without loss of generality.

When driving or excitation signals are applied to the excitation element 128 of the flavoured source 112, flavoured substances in the form of flavoured fume, vapour or aerosol will be released into the channel 117.

Heating currents, and/or nebulizing or atomizing vibrations, whether pulsed or continuous, are example of suitable driving or excitation signals for operation of the flavour source 112. Example nebulizing or atomizing vibrations for nebulizing or atomizing the flavoured substances of the flavour source 112 have amplitude and frequency operable to facilitate nebulization or atomization of the flavoured substances. Typical nebulizing or atomizing vibrations may be below 100 Hz or in the ultrasonic frequency range.

The excitation element 128 may comprise a heating element which is to convert the excitation signals into heat during fuming mode operation or a nebulizer such as a mesh vibrator or an ultra-sonic vibrator which is to convert pulsed or oscillatory signals into nebulizing vibrations during fuming mode operation as examples.

The flavoured source 112 contains substances for generating flavoured fume, vapour or aerosol when subject to excitation and is therefore a source of flavoured fume, vapour or aerosol. In example of electronic cigarettes, the flavoured source may contain nicotine based flavoured substances and/or non-nicotine based flavoured substances such as menthol, essential oil or other flavouring substances. The flavoured substances may be a glycol-based liquid, for example, one comprising a mixture of propylene glycol (PG), glycerin (G), and/or polyethylene glycol 400 (PEG400), and with or without nicotine.

In the examples, the second module 150B is a modular frontend comprising the puff detector 140, the excitation element 128 and a reservoir 130 containing the flavoured substances in liquid form. The flavoured substances may or may not contain nicotine. Such a modular frontend is commonly known as a ‘cartomizer’.

The charging circuitry 124 is to facilitate charging of the battery when an external charging power is applied to the charging terminals of the electronic smoke apparatus 100.

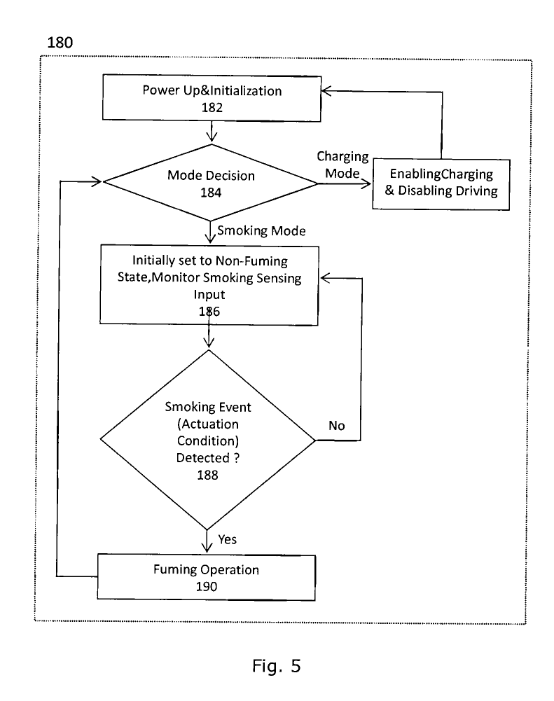

Referring to an example operation flow 180 as depicted in FIG. 5, the operation circuitry 120 is initialised on power up at 182 and will proceed to perform mode detection and mode decision operations at 184. When outcome of the mode decision indicates a charging mode operation, the charging circuitry 124 is activated and the driving circuitry 122 is deactivated or disabled. After charging operations have ended, the operation circuitry will be initialised on power up at 182. When outcome of the mode decision indicates a smoking mode operation, the decision circuitry 1264 will set its output to indicate a non-fuming state and monitor its smoking sensing input terminal to determine whether an actuation condition corresponding to a smoking event has been detected at 186. When an actuation condition is detected at 188, the decision circuitry 1264 will set a fuming state output and the control circuitry 126 will operate the driving circuitry 122 to drive the excitation circuitry 128 to produce fuming effects at 190. After a fuming effect has been produced, the operation circuitry will return to mode detection operation 184. If no actuation condition is detected at 188, the operation circuitry 120 will return to 186 to continue monitor smoking sensing input perform

An actuation condition in the context of simulated smoking such as electronic smoking means a condition of airflow inside the channel 117 signifying or indicating occurrence of simulated smoking inhalation at the inhaling aperture 116. A condition of airflow due to simulated smoking inhalation would mean inhalation suction at the inhaling aperture 116 which is characteristic of smoking inhalation. Inhalation suction which is characteristic of smoking inhalation has certain airflow rate threshold for a certain duration threshold and in an inhaling direction. An actuation signal in the context of simulated smoking means sensor signals indicative or representative of occurrence of an actuation condition at the electronic smoke apparatus.

An example actuation condition in the context of electronic smoke apparatus includes airflow in the channel 117 and in an inhaling direction with an inhaling flow rate exceeding a threshold. The inhaling direction is in a direction from the air inlet aperture 118 towards the inhaling aperture 116, or in a direction from the flavoured source 112 towards the inhaling aperture 116. Actuation conditions may include an inhaling duration exceeding an inhaling duration threshold. The puffing detector 140 is disposed in the electronic smoke apparatus to detect airflow conditions through the electronic smoke apparatus and to generate variable airflow status signals according to the detected airflow conditions.

In the example of FIGS. 1A, the contact terminals 152A and 154A are to operate as mode detection terminals, air movement signals reception terminals, excitation signal output terminals and charging input terminals. When a load having electrical properties is electrically coupled to the contact terminals 152A and 154A of the first module 150A, the electrical properties at the contact terminals will charge. When a charging voltage, for example, a 5V DC, is detected at the contact terminals 152A and 154A, the operation circuitry will set into the charging mode operation. On the other hand, if the electrical properties of an excitation element are detected at the contact terminals 152A and 154A, the operation circuitry will set into the smoking mode operation. For example, if the excitation element is a passive element such as a resistive element or an oscillator, a detection of their passive impedance properties would be definitive to set the operation circuitry into the smoking mode operation.

When the apparatus is in the smoking mode, the contact terminals 152A and 154A are to operate as reception terminals for receiving air movement signals sent from the puffin detector and, alternatively, as output terminals for delivering excitation signals to the excitation element 128. When the contact terminals 152A and 154A operate as signal reception terminals, air movement signals will be received at the contact terminals and delivered to the control circuitry for analysing and processing. When operating as excitation signal output terminals, excitation signal will be sent from the driving circuitry 122 to the excitation element 128 via the switching circuitry 129 and the contact terminals 152A and 154A. When the apparatus is in the charging mode, the contact terminals 152A and 154A are to operate as charging input terminals to receive charging current during charging operations.

The electronic smoke apparatus may comprise a manually operable switch on the housing to enable user to switch to select to operate in the charging mode or the fuming mode, such as that of FIG. 3.

Where the electronic apparatus are not in detachable modular form as that depicted in FIG. 1A, a charging terminal may be provided on the housing. The mode decision circuitry may comprise differentiation circuitry to sense and differentiate between a charging power source and an excitation circuitry or puff detector at a mode sensing terminal and to automatic switch into the charging mode or the fuming mode according to outcome of the sensing and differentiation.

When a load at the sensing terminal is sensed to have electrical properties characteristic of or associated with a charging power source, the mode decision circuitry will set the electronic smoke apparatus in the charging mode. When a load at the sensing terminal is sensed to have electrical properties characteristic of or associated with a flavour source or puff detector, the mode decision circuitry will set the electronic smoke apparatus to operate in the smoking mode.

In example embodiments, the mode decision circuitry may comprise differentiation circuitry to differentiate between a charging power source and an excitation circuitry 128 or puff detector 144 at the mode sensing terminal. The differentiation circuitry will generate a charging mode flag when a charging power source is detected at the mode sensing terminal and will generate a fuming mode flag when a flavour source or puff detector is detected at the mode sensing terminal.

In example embodiments, the differentiation circuitry may comprise a voltage sensing device to sense voltage at the mode sensing terminal. The differentiation circuitry will generate a charging mode flag when the voltage sensed at the mode sensing terminal corresponds to that of a charging power source. The differentiation circuitry will generate a fuming mode flag when the voltage sensed at the mode sensing terminal corresponds to that of an excitation circuitry or puff detector.

To operate in the fuming mode, the first and second modules are made into a single piece with the fastening counterparts in fastening engagement and with the counterpart contact terminals entering into corresponding electrical contact. When the apparatus is powered up to operate in the fuming mode, the control circuitry 126 which is configured to monitor the status of airflow inside the channel using the puffing detector 140 as a sensing frontend will constantly monitor status of airflow inside the channel.

When a user simulates tobacco smoking using the electronic smoke apparatus, the user will apply inhaling suction at the inhaling aperture. The inhaling suction thus applied will generate airflow in the channel. When the air flow has a direction and flow rate that satisfy the criteria of an actuation condition, the control circuitry 126 will generate excitation signals to operate the flavour source. Whether the air flow has a direction and flow rate that satisfy the criteria of actuation conditions will be determined by the decision circuitry with reference to the signal output of the puffing detector. An actuation condition is typically an inhaling suction resembling smoker puffing of smoker and is characterized by an air flow having a direction of inhaling and a flow rate equal to or exceeding a flow rate threshold. The duration of airflow may be used as an additional threshold criterion to determine whether airflow in the channel 117 qualifies as an actuation condition.

Upon detection of an actuation condition, the control circuitry will generate actuation signals and the driving circuit upon receipt of the actuation signals will generate excitation signals. When the excitation signals are received at the excitation circuitry, flavoured fume vapour or aerosol will be generated inside the channel and delivered to the inhaling aperture and the user in response to user's suction inhaling at the inhaling aperture.

When in the fuming mode, electrical power is delivered from the battery 114 to the excitation element 128 via the switching circuitry 129 and excitation current flows in a discharging direction. The excitation current has a relatively large magnitude in the Ampere region since excitation signals are required to generate a flavoured stream of air flow within a short time and well before the end of a smoking inhalation or puff. A typical excitation current for an electronic cigarette is in the region of 1-2 Amperes. The excitation current may be larger for an electronic smoke apparatus having a larger airflow channel or having a larger reservoir, such as in the case of electronic smoking pipe or tube or other larger smoking apparatus. The duration of full excitation current will tally with the puffing time which is typically in the region of 3-5 seconds. Of course, the duration of full excitation current can be higher such as between 5-10 seconds or lower, such as between 1-3 seconds according to user preference.

To facilitate charging of the battery 114, the first module 150A is detached from the second module 150B to expose the contact terminals on its axial free end. The contact terminals include a positive terminal 152A and a reference terminal 154A defined by the metallic housing of the first housing portion. When a charging voltage is detected at the positive terminal 152A with reference to the reference terminal 154A, the electronic cigarette will operate in the charging mode.

In an example charging mode operation as depicted in FIG. 1B, a charging power source having an output voltage of 5V is connected to the first module 150A. The charging power source 160 is in modular form and includes charging contact terminals which are complementary to the contact terminals on the first module 150A. When the charging power source is in electrical connection with the contact terminals 152A, 154A of the first module 150A, detection of the charging voltage by the control circuitry 126 will turn the electronic smoke apparatus to operate in the charging mode. While the charging mode may be set at 4.2V or other appropriate voltage values, a voltage which is higher than the instantaneous voltage of the battery may also be regarded as a charging voltage to facilitate charging of the battery.

When in the charging mode, electrical power is delivered from charging power source 160 to the battery 114, also via the switching circuitry 129 and the charging current flows in a charging direction opposite to the discharging direction.

Charging of the battery will normally span over a longer period of time and the magnitude of charging current is normally substantially lower than the excitation current. The magnitude of charging current is usually less than or equal to 50% of the magnitude of the full excitation current under normal operation conditions. Typically, the charging current is less than or equal to 30% or 40% of the magnitude of the full excitation current ad may be below 20% or even below 10%.

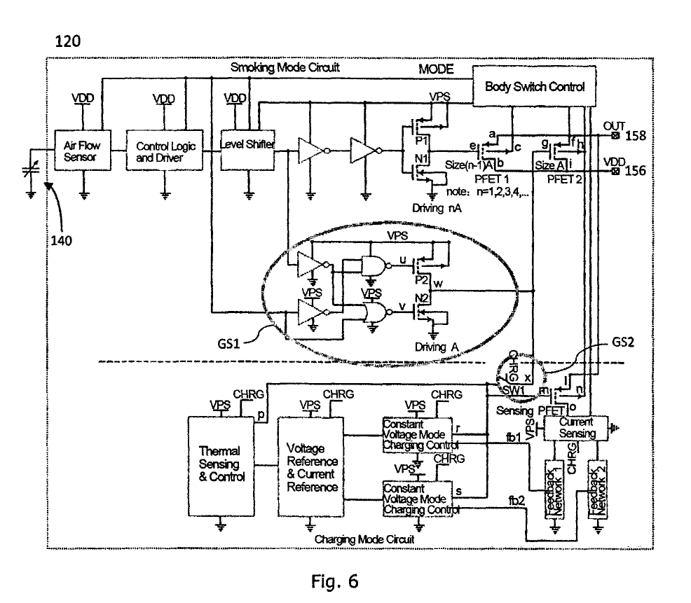

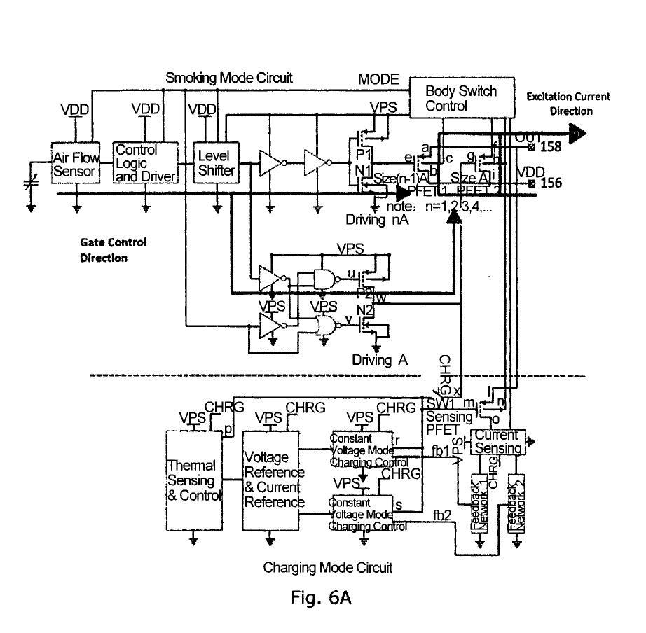

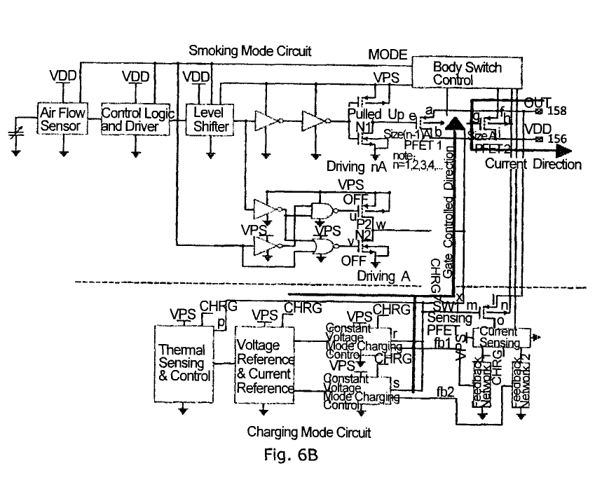

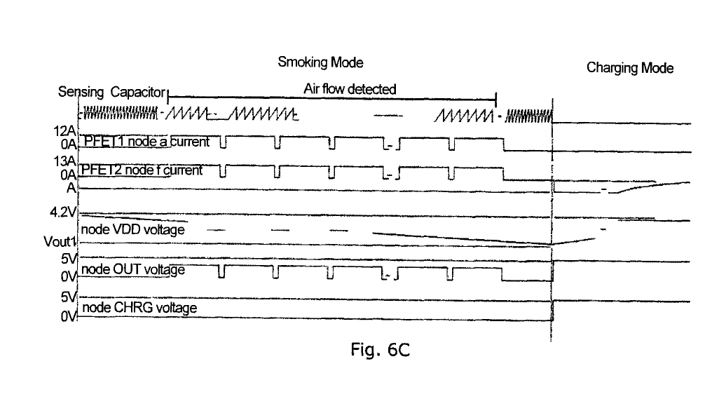

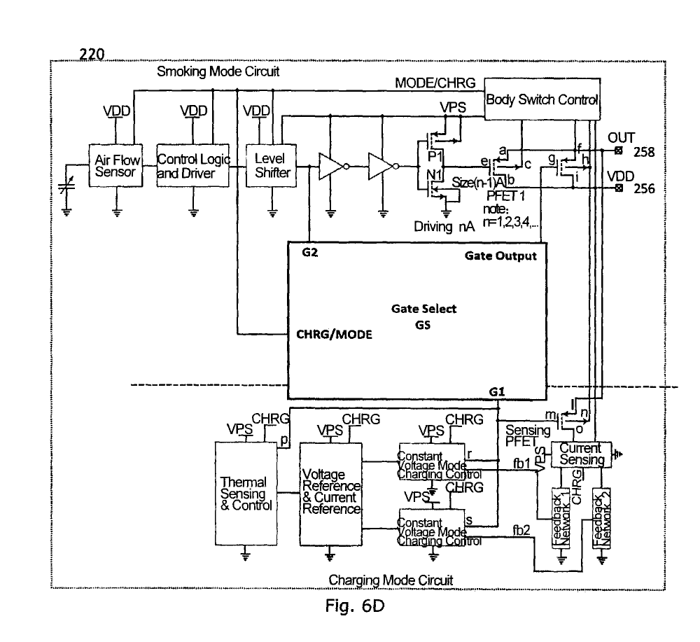

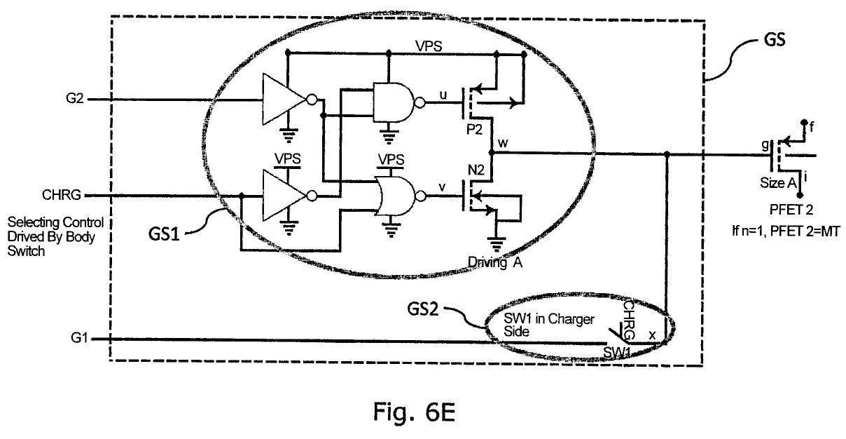

In an example operation circuitry 120 as depicted in FIG. 6, the mode sensing circuitry, mode decision circuitry and mode switching circuitry are represented collectively as a single mode operation module. The mode operation module has a “CHRG” output and a “VPS” output. In an example application, the smoking event sensing circuitry and the smoking state decision circuitry 1264A is connected to the output of the puffing detector 140, which is represented as a variable capacitor. The driving circuitry comprises a control and logic driver and a level shifter configured to drive a half bridge via a buffer comprising two inverters in series. The level shifter is to shift control logic swing from VDD to VPS. The half bridge comprises a P-type MOSFET P1 and an N-type MOSFET N1 which are connected in series between a switchable positive supply VPS and ground. The output of the half bridge is connected to the gate input ‘e’ of a first power MOSFET PFET1 having conductive terminals ‘a’ and ‘b’. A body terminal ‘c’ of PFET1 is connected to an output of the mode decision circuitry of the control circuitry. An output of the level shifter is branched out to connect to the gate input ‘g’ of a second power MOSFET PFET2 having conductive terminals ‘f’ and ‘i’. A body terminal ‘h’ of PFET1 is also connected to an output of the mode decision circuitry of the control circuitry. A gate select device GS is provided to facilitate selective actuation of PFET2. The gate select device GS comprises a first control portion GS1 and a second control portion GS2 as depicted in FIGS. 6D and 6E. The first control portion GS1 has a first input node G2 which is connected to the level shifter output, a second input node which is connected to the CHRG signal line, and an output node connected to the gate terminal ‘g’ of PFET2. The second control portion GS2 has an input node G1 which is connected to various control nodes of the charging circuitry including output node P of the thermal sensing control module and an output node which is connected to the gate terminal ‘g’ via a switch SW1. The switch SW1 is open to enable smoking mode operations and to disable charging or the charging circuitry when the ‘CHRG’ signal is LO (logical low) and to enable charging circuitry and disable smoking mode operations when the ‘CHRG’ signal is High (logic high).

The operation circuitry is connected to a power supply rail V_{DD}. V_{DD} is the output voltage of the battery 114 and the battery is connected to the battery contact terminal 156 of the operation circuitry. The power supply to the half bridge is VPS which is powered by the battery when in the smoking mode and powered by an external power source when in the charging mode. When in the smoking mode, the signal “CHRG” of the mode sensing and switching circuitry is set to LO to enable the driving circuitry and to disable the charging circuitry. The “CHRG” signal is logically opposite to the “MODE” signal.

When in fuming mode operations, the driving circuitry generates driving signals in the form of switched pulse trains by means of the control and logic driver and the level shifter. The switched pulse trains of the driving circuitry will operate the half bridge which is connected to the serial connected inverter output to drive PFET1. The same switched pulse trains of the driving circuitry will operate another half bridge of the gate select device portion GS1 to drive PFET2 in synchronization. During fuming operations, PFET1 and PFET are driven in synchronous conduction to deliver excitation signals from the battery to the excitation element 128. When in fuming operation, excitation power flows from the battery contact terminal or V_{DD} terminal 156 to the OUT terminal 158 via the conduction path formed by both PFET1 and PFET2 of the MOSFET assembly, as depicted in FIG. 6A. When in this smoking mode, switch SW1 is open to disconnect the gate terminal ‘g’ of PFET 2 from the charging circuitry.

The driving circuitry is to deliver switching modulation signals such as PWM signals to drive the two half bridges and to output excitation signals at the output terminal 158 via a power MOSFET assembly comprising PFET1 and PFET2 when in the smoking mode. The power MOSFET assembly comprises parallel connected power MOSFETs PFET1 and PFET2 which collectively define a current conduction path for delivery of excitation power from the battery to the output terminal 158.

The charging circuitry may comprise thermal sensing and control circuitry, voltage reference and current reference circuitry, a constant voltage mode charging control, a constant current charging mode control, a first feedback network for voltage feedback to the constant voltage mode charging control via a first feedback path fb1, a second feedback network for current feedback to the constant current mode charging control via a second feedback path fb2 and a current sensing network connected to a current sensing filed effect transistor FET. The thermal sensing and control circuitry is to prevent the charging circuit module from overheating during charging. Voltage and current reference circuitry is to provide referencing and biasing for the charging circuit. When battery voltage is low, (normally <4.1V), constant current charging will be initialised and the constant current charging mode control circuitry will operate to provide a constant charging current to charge the battery. The charging current is monitored through a feedback network fb2 via a PFET as a current sensor. When the battery is nearly fully, constant voltage charging will take place and the constant voltage mode charging control circuit will take over to charge the battery to a fully charged voltage (normally 4.2V, some may require charged to 4.3V). The charging current is monitored through feedback network 1 fb1 during this constant voltage charging mode. When in the battery charging mode, the output “CHRG” of the mode sensing and switching circuitry is set to disable the driving circuitry and to enable the charging circuitry to facilitate charging by an external charging power connected to the terminal 156. When in the charging mode, the first control portion GS1 of the gate select GS device is disabled such that the output of the half bridge of the gate select device is floating and the switch SW1 of the second control portion GS2 is closed to connect the gate terminal ‘g’ of PFET 2 to the charging circuitry and isolated from the driving circuitry.

When in charging operations, charging current will flow from the OUT terminal 158 into the battery contact terminal 156 and then into the battery 114 via PFET1 only, as depicted in FIG. 6B.

Referring to the time diagram of FIG. 6C, both smoking mode and charging mode operations are shown for the electronic smoke apparatus. Initially, air movement signals from the puffing detector were received as capacitance values after processed by the sensing circuitry. At this time, no current flows through PFET1 or PFET2, and the CHRG signal is at low or 0V, representing smoking mode operation. When an actuation event is detected, the electronic smoke apparatus or the processing circuitry enters into the fuming mode or fuming state. When in the fuming state, an excitation current flows through PFET1 and flow out of node ‘a’ to terminal 158 and then to drive the excitation element 128. Current at node ‘f’ of PFET2 is in synchronization with that at node ‘a’ of PFET1. When no actuation condition is detected at a subsequent time, the electronic smoke apparatus or the processing circuitry will return to a non-fuming state or a standby mode. During the time period, which could mean many simulated smoking cycles, the battery voltage V_{DD} drops in a gradual and continuous manner. When the battery voltage drops to a low level, battery charging is required. At this time, the second module 150B will be detached from the first module 150A. When a charging source is connected to the contact terminals 152A, 154A, the operation circuitry upon detection of the charging voltage of the charging source will switch into the charging mode and perform charging operations, as depicted in the charging mode portion of FIG. 6C. The gate select device is functionally depicted in FIG. 6D and shown in more detail in FIG. 6E.

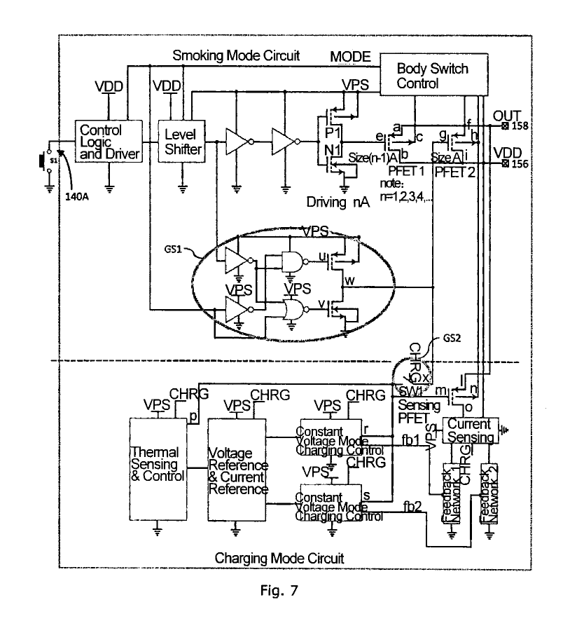

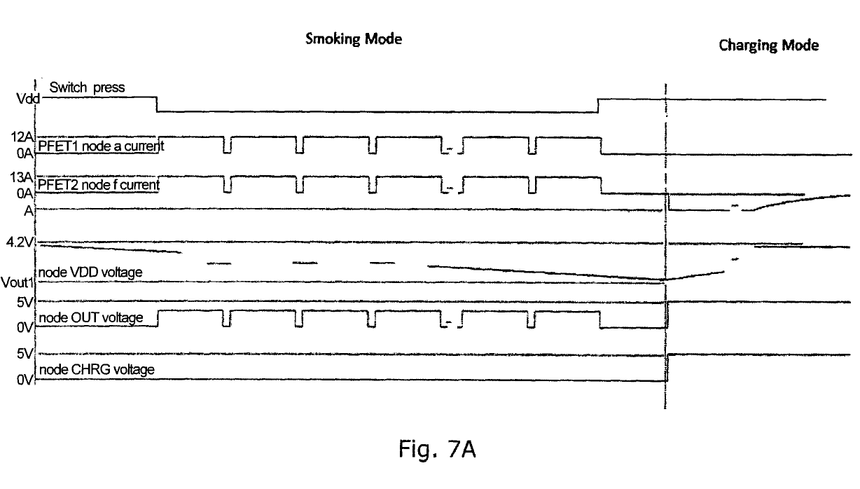

In another example application as depicted in FIG. 7 with reference to the apparatus 500 of FIG. 3, the puff detector is replaced by a mode switch 140A which is connected to the control logic and driver of the operation circuitry 200. Upon activation of the mode switch 140A, the apparatus 500 will move into the fuming mode and generates flavoured fume by sending excitation power to the excitation element. At this time the activation signal (switch press) will change from high (say Vdd) to low, as depicted in FIG. 7A. When the mode switch 140A is de-activated, the activation signal (switch press) will return from low to high. When a charging power is connected to the OUT pin, the OUT pin will be pulled up to say 4.5 to 5V and the apparatus will operate in the charging mode.

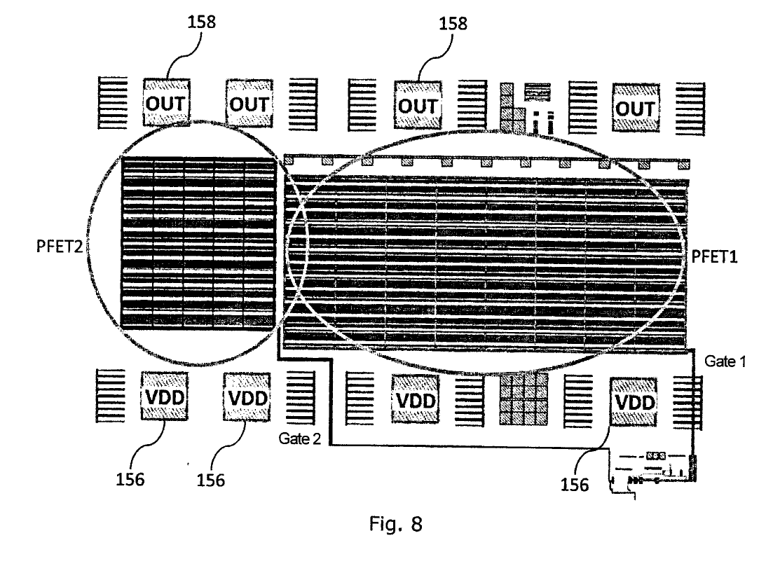

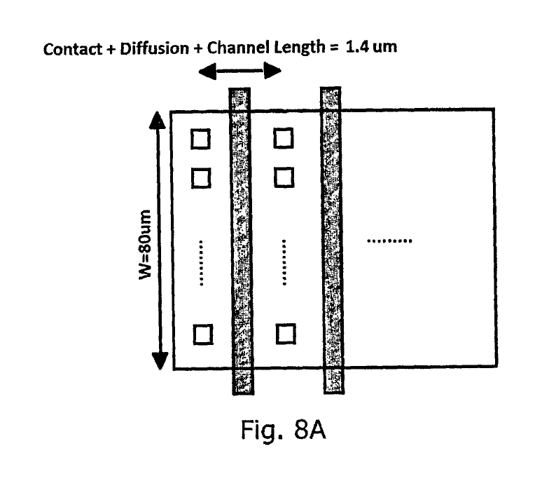

In the example integrated circuit layout of the example operation circuitry as depicted in FIG. 8, PFET1 has an area of about 216,000 μm and PFET2 has an area of about 79,800 μm. The total area due to PFET1 and PFET2 is about 295,800 μm. In another example, PFET1 has a larger die area of about 295,800 μm to provide a larger current rating, and PFET2 has a die area of about 79,800 μm. The total die area due to PFET1 and PFET2 is about 375,600 μm. By selectively using PFET2 as a part of the discharging path (or the first switchable conductive path) or as a charging path (or the second switchable conductive path), the conduction path area to be used for charging can also be used a part of the discharging path, thereby saving substrate area substantially and enhance substrate utilization efficiency.

The larger die area of PFET2 would provide enhanced current handling capability during charging and discharging mode operations and this would be beneficial for electronic smoke apparatus currently known as the “EGO” type which requires a charging current of 300-500 mA. Such a charging current is 3-5 times higher than the charging current of electronic cigarettes and enhance optimised semiconductor chip area efficiency.

The current handling capability of the discharging path and the charging path is determined by the resistance or the internal resistance of the conduction path. The substrate area of PFET and PFET2, and their relative area can be made according to current handling requirement without loss of generality.

For example, for a MOSFET having an ON-resistance, R_{ds}, of 0.15 Ohm is required to deliver an excitation current of 1 A to a resistive heater when the battery voltage is about 3.8V, the PMOSFET will operate in the linear region to deliver a conduction current across its conduction terminals. This conduction current will be the drain current I_{d} of the PMOSFET and the PMOSFET drain current has the following relationship:

$${I}_{d} = μ Cox \frac{W}{L} ( {V}_{gs} - {V}_{th} - \frac{{V}_{ds}}{2} ) {V}_{ds} ,$$

where

$${I}_{d} = \frac{{V}_{ds}}{{R}_{ds}} ,$$

L is the channel length of the PMOSFET, W is the total channel width of the PMOSFET, μ is the charge-carrier effective mobility, Cox is the gate oxide capacitance per unit area, V_{ds} is the voltage across the drain and the source of the PMOSFET during conduction, V_{gs} is the voltage across the gate and the source of the MOSFET during conduction, Vₜₕ is the PMOSFET turn on threshold voltage.

Therefore,

$${R}_{ds} = \frac{\frac{L}{W}}{μ Cox ( {V}_{gs} - {V}_{th} - \frac{{V}_{ds}}{2} )} ,$$

where I_{d} is 1A as required in this example,

In the example of FIGS. 6 and 7, the drain terminal of the MOSFET is the node connected to output node 258 and the source terminal is the node connected to battery node 256.

Assuming V_{ds}≈0.15V, μCox=10uA/V²,Vₜₕ=1V, and V_{gs}=battery voltage=3.8V when fully turned on,

$$\frac{L}{W} = 0.15 \times 10 E - 6 \times ( 3.8 - 1 - 0.15 / 2 ) ⇒ \frac{W}{L} = 240 , 000.$$

Using minimum channel length calculation and assuming 0.5 um, W would equal 130,000 μm. If a finger width W of 80 um is selected, the number of fingers required to form a MOSFET as depicted in FIG. 8A would be 1625. The cumulative length of the fingers (Total Length) would be as follows:

Total Length=Metal Contact Length+Diffusion Length+Channel Length.

Assuming a metal contact length of 0.5 μm and a lateral diffusion length of 0.2 um, the total diffusion length will be 0.4 μm and the total length for each finger will be 1.4 μm (0.5+0.4+0.5). The lateral diffusion length is a left and right spread from the channel. Therefore, each finger has an area of 1.4*80 um̂2 and the total MOSFET area is 1.4*80*1625=182,000 um̂2.

Where the excitation power being driven is high, additional substrate contacts will be added and a gate connect will be added for every ten fingers as a typical example. Under such circumstances, total area would be about 295,800 um̂2, taking into account additional substrate pick-up and metal density.

When operating in the charging mode, the MOSFET will operate in the saturation region, and the gate voltage to facilitate constant current mode charging would be about 2.9V. This gate voltage would be regulated by means of a closed-loop feedback system having a current sense module to monitor current flow to maintain an example charging current of say 380 mA with a power source voltage of 5V.

In the charging mode, the source terminal of MOSFET is defined as the node connected to power source and drain is defined as the node connected to battery. In saturation region,

$${I}_{d} = \frac{1}{2} μ Cox \frac{W}{L} ( {( {V}_{gs} - {V}_{th} )}^{2} ( 1 + λ ( {V}_{ds} - {V}_{dsat} ) ) ) ,$$

where I_{d} is the drain current in constant current mode charging, which is equal to charging current 380 mA, λ is the channel-length modulation parameter, and V_{dsat} is the overdrive voltage. If we neglect this parameter,

$${I}_{d} = \frac{1}{2} μ Cox \frac{W}{L} {( {V}_{gs} - {V}_{th} )}^{2} \cdot {V}_{gs} = \vert {V}_{g} - {V}_{s} \vert = 5 V - 2.9 V = 2.1 V . \\ μ Cox = 10 uA / {V}^{2} , \\ {V}_{th} = 1 V . \frac{W}{L} = 380 E - 3 / ( 5 E - 6 {( 2.1 - 1 )}^{2} ) ∼ = 60 , 000.$$

Using L=0.5 um, W=30,000 um. Using finger=80 um, number of finger=375. Total area=1.4*80*375=42,000 um̂2. Since driving is high power, many substrate contact will be added and gate connect will be added for every ten finger. Including substrate pick-up and metal density, total area is about 79,800 um̂2.

By selective using part of the area of 79,800 um̂2 of 295,800 um̂2 of the MOSFET for discharging, a total MOSFET area of 295,800 um̂2 would be adequate for both charging and discharging operations for the apparatus.

While the disclosure has been described herein with reference to examples, the examples are not intended and should not be used to limit the scope of disclosure.

1. An electronic smoking apparatus comprising control circuitry, driving circuitry, charging circuitry, excitation element, a flavoured source and a battery, the electronic smoking apparatus being operable in a smoking mode or a charging mode; wherein excitation signals are to flow from the battery to the excitation element through a first switchable conductive path and in a first conduction direction when the electronic smoking apparatus operates in the smoking mode, and charging current is to flow from an external charging power source to the battery through a second switchable conductive path and in a second conduction direction when the electronic smoking apparatus operates in the charging mode, the second conduction direction being opposite to the first conduction direction; and wherein the second switchable conductive path forms a portion of the first switchable conductive path.

2. (canceled)

3. The electronic smoking apparatus according to claim 1, wherein the first switchable conductive path is switchable between a first conductive state corresponding to a highly conductive state and a second conductive state corresponding to lowly conductive or non-conductive state, and the control circuitry is to generate driving signals to repeatedly switch the conductive states of the first switchable conductive path to modulate the excitation signals during smoking operation.

4. The electronic smoking apparatus according to claim 1, wherein the second switchable conductive path is switchable between the first conduction direction and the second conduction direction.

5. The electronic smoking apparatus according to claim 1, wherein the first switchable conductive path comprises the second switchable conductive path and a third switchable conductive path, the second switchable conductive path and the third switchable conductive path being independently operable, independently controllable and/or independently switchable.

6. The electronic smoking apparatus according to claim 5, wherein the conductive direction of the second switchable conductive path being switchable independently of the conductive direction of the third switchable conductive path.

7. The electronic smoking apparatus according to claim 5, wherein the third conductive path is switchable between the first conductive state and the second conductive states by switching signals from a first driving signal path, and the second conductive path is switchable between the first conductive state and the second conductive states by switching signals from a second driving signal path, and wherein the second driving signal path is a branch of the first signal driving path and is switchable to be electrically isolated from the first signal driving path.

8. The electronic smoking apparatus according to claim 7, wherein the second driving signal path is to be switched to connect to the first signal driving path when in smoking mode operations and to be switched to isolate from the first signal driving path when in charging mode operations.

9. The electronic smoking apparatus according to claim 7, wherein the conductive states of the third conductive path are switchable by application of control signals at a control terminal thereof, and the first signal driving path connects the driving circuitry to the control terminal; and wherein the first signal driving path comprises a half bridge, the half bridge having an input connected to the driving circuitry via a switching buffer and having its output connected to the control terminal.

10. The electronic smoking apparatus according to claim 7, wherein the conductive states of the second switchable conductive path are switchable by application of control signals at a second control terminal thereof, and the second signal driving path connects the driving circuitry to the second control terminal; and wherein the second signal driving path comprises a half bridge, the half bridge having an input connected to the driving circuitry via a switching buffer and having its output connected to the control terminal.

11. The electronic smoking apparatus according to claim 7, wherein the first and second signal driving paths are isolated from the driving circuitry, and the control terminal of the second switchable conductive path is connected to the charging circuitry to enable battery charging when in the charging mode.

12-18. (canceled)
